(19) United States
(12) Patent Application Publication
(10) Pub. No.: US 2014/0071895 A1
(43) Pub. Date: Mar. 13, 2014

(54) Network Selection Based On Customizing Crowdsourced Connection Quality Data

(71) Applicants: Ryan H. Bane, Redmond, WA (US); Adam R. Dyba, Redmond, WA (US); Brent E. Ford, Sammamish, WA (US); Aurelio Navarro Belletti Garcia, Issaquah, WA (US); James Christopher Gray, Redmond, WA (US); Shai Guday, Redmond, WA (US); Tyler E. Hennessy, Woodinville, WA (US); Ayman Kaheel, Bellevue, WA (US); Triptpal Singh Lamba, Bothell, WA (US); Darya Mazandarany, Kirkland, WA (US); Michael Hao Mi, Redmond, WA (US); Sidharth Uday Nabar, Seattle, WA (US); Christopher R. Rice, Redmond, WA (US); Peter Schmatz, Sammamish, WA (US); Michael Svanholm Thomsen, Redmond, WA (US)

(72) Inventors: Ryan H. Bane, Redmond, WA (US); Adam R. Dyba, Redmond, WA (US); Brent E. Ford, Sammamish, WA (US); Aurelio Navarro Belletti Garcia, Issaquah, WA (US); James Christopher Gray, Redmond, WA (US); Shai Guday, Redmond, WA (US); Tyler E. Hennessy, Woodinville, WA (US); Ayman Kaheel, Bellevue, WA (US); Triptpal Singh Lamba, Bothell, WA (US); Darya Mazandarany, Kirkland, WA (US); Michael Hao Mi, Redmond, WA (US); Sidharth Uday Nabar, Seattle, WA (US); Christopher R. Rice, Redmond, WA (US); Peter Schmatz, Sammamish, WA (US); Michael Svanholm Thomsen, Redmond, WA (US)

(21) Appl. No.: 14/081,196

(22) Filed: Nov. 15, 2013

Related U.S. Application Data
(63) Continuation-in-part of application No. 13/850,284, filed on Mar. 25, 2013.
Application No. 13/850,284 is a continuation of application No. 12/333,331, filed on Dec. 12, 2008, now Pat. No. 8,407,721.

(51) Int. Cl. H04W 48/18

(52) U.S. Cl. CPC H04W 48/18
USPC 370/328

(57) ABSTRACT

Embodiments select networks for connection based on application-specific quality scores. A request is received from an application for a network connection. Connection quality data for nearby networks is accessed. The connection quality data is derived from crowdsourced data. The connection quality data is adjusted based on a device context to produce an application-specific quality score for each of the networks. One or more of the networks are selected for connection based on the application-specific quality scores. In some embodiments, a single network connection endpoint is provided to the application to abstract connection management details from the application.

### CROSS-REFERENCE TO RELATED APPLICATIONS

This application is a continuation-in-part of U.S. patent application Ser. No. 13/850,284, filed Mar. 25, 2013, entitled “Communication Interface Selection on Multi-Homed Devices”, which is a continuation of U.S. Pat. No. 8,407,721, issued Mar. 26, 2013, the entire disclosures of which are hereby incorporated by reference herein for all purposes.

This application is related to a U.S. patent application entitled “Context-based Selection of Instruction Sets for Connecting Through Captive Portals,” which is incorporated by reference herein in its entirety.

### BACKGROUND

With the increased popularity of smart telephones, tablets, and other mobile devices, there has been an increase in the quantity of networks available to these mobile devices. However, different networks often provide different levels of service, such as bandwidth, security, and latency. As such, one network may be suitable for one application, but not for another. Some existing systems are not capable of selecting the most appropriate network for a given application, mobile device, user, time, location, etc.

For example, voice over Internet Protocol (VoIP) calls have become a viable alternative to circuit switched calls (e.g., over cellular networks) on the mobile devices. However, at least because of the portable nature of mobile devices and the variable quality of wireless fidelity (Wi-Fi) and cellular data networks, the quality of a VoIP call may be low over some of the networks. However, with some of the existing systems, the mobile device is unable to determine that the VoIP call is likely to be of low quality before the call is placed.

### SUMMARY

Embodiments of the disclosure select one or more networks for connection based on context-specific quality scores for the networks. A request is received from an application or a user for a network connection. Connection quality data for each of a plurality of available networks is accessed. The connection quality data is derived from crowdsourced data received from a plurality of computing devices. The connection quality data is adjusted based on a device context to produce a context-specific quality score for each of the available networks. One or more of the available networks are selected for connection based on the context-specific quality scores.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a mobile computing device having access to a plurality of networks, such as wireless fidelity (Wi-Fi), cellular, and satellite.

FIG. 2 is an exemplary block diagram illustrating the mobile computing device from FIG. 1 calculating context-specific quality scores for available networks based on device context and crowdsourced connection quality data.

FIG. 3 is an exemplary flow chart illustrating operation of a computing device to select a network based on context-specific quality scores and to provide the application with a single abstracted network connection endpoint to connect to the selected network.

FIG. 4 is an exemplary flow chart illustrating operation of a computing device to calculate context-specific quality scores for available networks, and to present the networks and scores to a user for selection.

FIG. 5 is an exemplary user interface illustrating context-specific quality scores for a plurality of networks available to a computing device.

FIG. 6 is an exemplary user interface illustrating network characteristics available for adjustment by a user.

FIG. 7 is an exemplary user interface illustrating suggested applications based on network performance.

Corresponding reference characters indicate corresponding parts throughout the drawings.

### DETAILED DESCRIPTION

Referring to the figures, embodiments of the disclosure refine network connection quality data 206 crowdsourced from a plurality of computing devices to produce context-specific quality scores 210 for an application 110. The connection quality data 206 is refined or otherwise adjusted based on a device context 208. Based on the context-specific quality scores 210, one or more available networks 108 are selected for connection. In some embodiments, the application 110 is provided with a single, abstracted network connection endpoint for connection to the selected networks 108.

In some embodiments, the connection quality data 206 for the networks 108 represents the predicted, future network quality from those networks 108. The connection quality data 206 is received from a cloud service 104 and leveraged to select the right network connection for a particular one of the application 110 given the device context 208.

Aspects of the disclosure offload connection management decisions from the applications 110 to other modules or services executing on a mobile computing device 102 (e.g., an operating system, network layer service, etc.). Given the device context 208 and the crowdsourced connection quality data 206, exemplary embodiments operate to select, for each application 110, the best connection with the lowest cost without sacrificing the user experience.

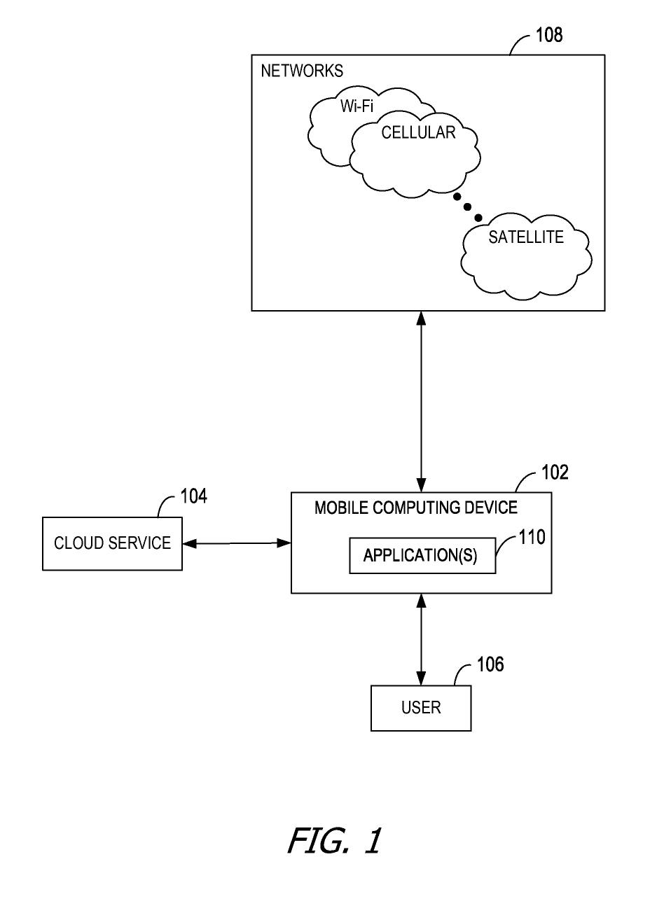

Referring next to FIG. 1, an exemplary block diagram illustrates the mobile computing device 102 having access to a plurality of the networks 108, such as wireless fidelity (Wi-Fi), cellular, and satellite. In the example of FIG. 1, a user 106 interacts with the mobile computing device 102, or any other computing device of the user 106. The mobile computing device 102 executes one or more of the applications 110. During execution, the applications 110 may attempt to communicate with other devices across one or more of the networks 108. For example, the applications 110 may attempt to transmit and/or receive data over a Wi-Fi network, a cellular network, a satellite network, a whitespace network, or any other network 108. As described further herein, the mobile computing device 102 communicates with the cloud service 104 to select one or more of the networks 108 for each of the applications 110 requesting a network connection.

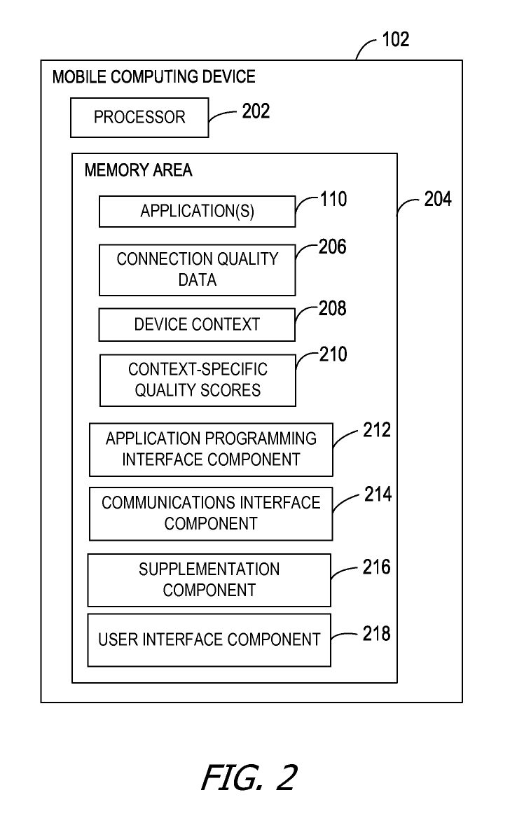

Referring next to FIG. 2, an exemplary block diagram illustrates the mobile computing device 102 from FIG. 1 calculating the context-specific quality scores 210 for available networks 108 based on the device context 208 and crowdsourced connection quality data 206. While some embodiments, such as FIG. 2, are described with reference to the mobile computing device 102, aspects of the disclosure are operable with any device executing instructions (e.g., as application programs, operating system functionality, or both) to implement the operations and functionality described herein. For example, in some embodiments, the mobile computing device 102 includes any portable device, such as a mobile telephone, laptop, tablet, computing pad, netbook, gaming device, and/or portable media player. In other examples, the mobile computing device 102 may include less portable devices such as desktop personal computers, kiosks, tabletop devices, industrial control devices, wireless charging stations, and electric automobile charging stations. Additionally, the mobile computing device 102 may represent a group of processing units or other computing devices.

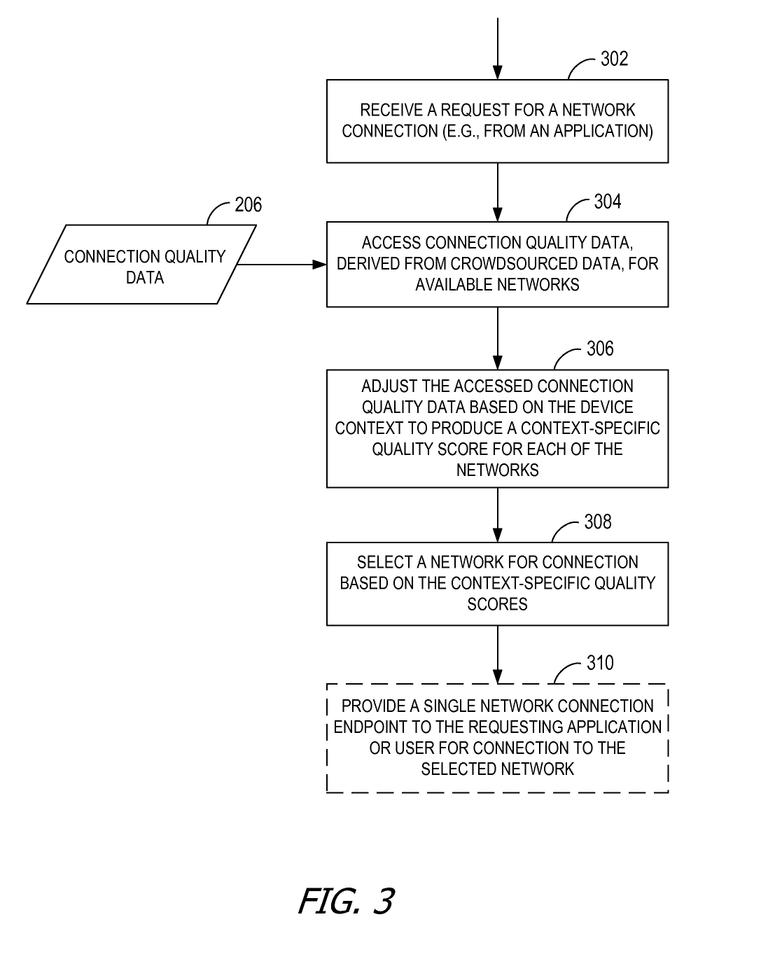

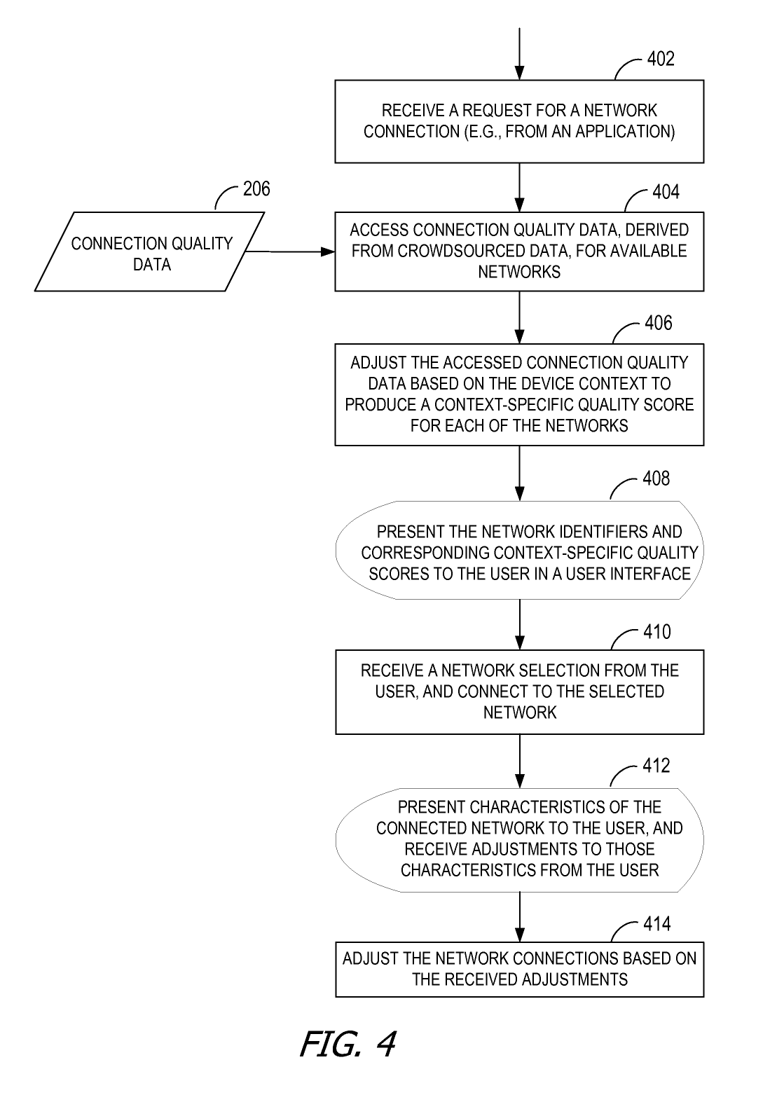

In some embodiments, the mobile computing device 102 has at least one processor 202 and a memory area 204. The processor 202 includes any quantity of processing units, and is programmed to execute computer-executable instructions for implementing aspects of the disclosure. The instructions may be performed by the processor 202 or by multiple processors executing within the mobile computing device 102, or performed by a processor external to the mobile computing device 102. In some embodiments, the processor 202 is programmed to execute instructions such as those illustrated in the figures (e.g., FIG. 3 and/or FIG. 4).

In some embodiments, the processor 202 represents an implementation of analog techniques to perform the operations described herein. For example, the operations may be performed by an analog computing device and/or a digital computing device.

The mobile computing device 102 further has one or more computer readable media such as the memory area 204. The memory area 204 includes any quantity of media associated with or accessible by the mobile computing device 102. The memory area 204 may be internal to the mobile computing device 102 (as shown in FIG. 2), external to the mobile computing device 102 (not shown), or both (not shown). In some embodiments, the memory area 204 includes read-only memory and/or memory wired into an analog computing device.

The memory area 204 stores, among other data, one or more of the applications 110. The applications 110, when executed by the processor 202, operate to perform functionality on the mobile computing device 102. Exemplary applications 110 include mail application programs, web browsers, calendar application programs, address book application programs, messaging programs, media applications, location-based services, search programs, and the like. The applications 110 may communicate with counterpart applications or services such as web services accessible via one or more of the networks 108. For example, the applications 110 may represent downloaded client-side applications that correspond to server-side services executing in a cloud.

In some embodiments, each of the applications 110 communicates with a “connection manager” or other logic executing on the mobile computing device 102 to identify and acquire one or more network connections given the requirements, preferences, and/or policies of the application 110. For example, each of the applications 110 may provide values identifying desired connection characteristics, such as bandwidth.

The memory area 204 further stores the connection quality data 206 for each of a plurality of the networks 108. In some embodiments, the mobile computing device 102 stores the connection quality data 206 for the networks 108 available to the mobile computing device 102 at a current time, networks 108 to which the mobile computing device 102 has connected at some point prior to the current time, networks 108 to which the mobile computing device 102 may connect in the future, and/or other networks 108.

In an embodiment such as shown in FIG. 1, the mobile computing device 102 communicates with the cloud service 104 to obtain the connection quality data 206 and stores the connection quality data 206 in the memory area 204. The mobile computing device 102 may obtain the connection quality data 206 from the cloud service 104 upon demand (e.g., by the user 106 or the applications 110), periodically and/or intermittently (e.g. as part of a daily batch), and/or as pushed content. In some embodiments, the mobile computing device 102 obtains the connection quality data 206 in one or more data structures (e.g., tiles) that store data describing networks 108 available near the mobile computing device 102 (e.g., within a particular geographic area or distance from the mobile computing device 102).

As an example, the tiles may store information such as a service set identifier (SSID) and basic service set identifier (BSSID) of network access points, the locations of the network access points, and the connection quality data 206 of the network access points. The tiles may further store attributes of the connection quality data 206, such as a time of day, an expiration value, and/or a confidence level (e.g., an amount or quantity of data input to calculate the connection quality data 206). In some embodiments, the expiration value for the connection quality data 206 for a particular network 108 is based on the stability of that particular network 108. Each tile is associated with a particular geographic area, and may be downloaded (e.g., once a day) by the mobile computing device 102 for caching.

The connection quality data 206 for each of the networks 108 describes the anticipated, expected, and/or predicted experience of the applications 110 that transmit and/or receive data over that network 108. The connection quality data 206 may also identify minimum, average/median, and/or maximum network characteristics or property values. For example, the connection quality data 206 may identify a minimum data rate, an average latency, and/or a mean signal-to-noise ratio.

In some embodiments, the connection quality data 206 includes a score that is represented as a numerical rating (e.g., zero to five with zero being poor and five being excellent) and/or a star rating (e.g. zero to five stars with zero stars being poor and five stars being excellent). As described further herein, the score received as part of the connection quality data 206 may be referred to as a baseline score, which is then re-scored (e.g., adjusted) by the mobile computing device 102 based on, for example, the specific user 106, mobile computing device 102, location, or other device context 208 to produce the context-specific quality score 210. The score may also be expressed as a formula and/or model that takes context (e.g., signal strength of a currently connected Wi-Fi access point) as a parameter to provide a more refined context-based score.

The connection quality data 206 is produced, generated, calculated, derived, and/or determined by the cloud service 104, in some embodiments, based on crowdsourced data received from a plurality of computing devices. For example, each of a plurality of mobile telephones provides the cloud service 104 with data describing the experience of the mobile telephone over a particular network 108 over time. The data represents measurements or observations of the mobile telephones. The cloud service 104 crowdsources such data by aggregating the data from each of the mobile telephones, and may perform mathematical operations on the aggregated data to produce the connection quality data 206 (e.g. apply machine-learning techniques). The connection quality data 206 is then distributed to the mobile computing devices 102.

In some embodiments, the cloud service 104 manipulates the crowdsourced data to implement congestion control to shape network traffic to prevent overloading particular networks 108. For example, if the cloud service 104 produces connection quality data 206 indicating that a particular network 108 provides excellent quality, then too many mobile computing devices 102 may attempt to connect to the particular network 108, resulting in congestion for that network 108. As such, the cloud service 104 may manipulate the connection quality data 206 for the particular network 108 to disfavor that network 108 (e.g., lower a quality score), based on the quantity of mobile computing devices 102 that have received the connection quality data 206 for that particular network 108 and/or after receiving feedback from the mobile computing devices 102 that have connected to that network 108.

The memory area 204 further stores the device context 208. The device context 208 describes the current (and/or recent and/or past) operating conditions and/or parameters of the mobile computing device 102. For example, the device context 208 represents measurements of signals available to the mobile computing device 102. In some embodiments, the device context 208 includes, but is not limited to, time, date, a battery level, signal strengths for the networks 108, network types for the networks 108, network speeds, a location of the mobile computing device 102, a user identifier, a user profile, device conditions, user preferences, user dwell time on the networks 108 (e.g., to favor those networks 108 with a longer/higher dwell time), a usage scenario, application identifiers of the executing and/or installed applications 110, device movement (e.g., from an accelerometer, gyroscope, and/or a global positioning system), weather local to the mobile computing device 102, device type and build, operating system type and build, data transmission costs, and/or a remaining network data consumption amount under a data plan.

The memory area 204 further stores the context-specific quality scores 210 for each of the networks 108. Calculation of the context-specific quality scores 210 is described below with reference to FIG. 3, and FIG. 4. In some embodiments, different applications 110 may have different quality scores for the same network 108.

The memory area 204 further stores one or more computer-executable components. Exemplary components include an application programming interface (API) component 212, a communications interface component 214, a supplementation component 216, and a user interface (UI) component 218. Operation of these components, when executed, is described below with reference to FIG. 4.

The mobile computing device 102 may further have one or more subscriber identity modules (SIMs). In a multiple SIM embodiment, the SIMs are in a dual SIM or dual standby mode where one connection is in a standby mode. In another multiple SIM embodiment, the SIMs are in a dual SIM dual active mode where both connections are independently active. Further, aspects of the disclosure are operable in soft SIM environments in which separate data usage plans (e.g., user agreements with mobile operators) are dynamically activated as needed.

Referring next to FIG. 3, an exemplary flow chart illustrates operation of a computing device to select at least one of the networks 108 based on the context-specific quality scores 210 and to provide the application 110 with a single abstracted network connection endpoint to connect to the selected network 108. In some embodiments, such as next described, the computing device is the mobile computing device 102 illustrated in FIG. 1 and FIG. 2. However, aspects of the disclosure contemplate performance of the operations illustrated in FIG. 3 by entities other than the computing device, such as the cloud service 104.

At 302, the mobile computing device 102 receives a request from one of the applications 110 for a network connection. For example, when the application 110 wants to send and/or receive data, the application 110 requests a list of available networks 108 and context-specific quality scores 210 for each. In other embodiments, the mobile computing device 102 receives the request from the user 106. In still other embodiments, the request originates from an operating system of the mobile computing device 102 that detects that one or more of the networks 108 are within range of the mobile computing device 102. In such embodiments, the mobile computing device 102 automatically connects, as described herein, without a trigger from the user 106 or an application 110.

At 304, the mobile computing device 102 accesses the connection quality data 206 for each of a plurality of the networks 108. For example, the mobile computing device 102 obtains the connection quality data 206 from the cloud service 104 for networks 108 local to or otherwise available (e.g., visible or detectable) to the mobile computing device 102. In such an example, the mobile computing device 102 sends a list of the visible networks 108 to the cloud service 104, and the cloud service 104 returns the connection quality data 206 for the networks 108 on the list. In another example, the mobile computing device 102 obtains the connection quality data 206 from the cloud service 104 for networks 108 to which the mobile computing device 102 is currently connected and/or for networks 108 to which the mobile computing device 102 is currently disconnected.

As described with reference to FIG. 2, the connection quality data 206 is derived (e.g., by the cloud service 104) from crowdsourced data received from a plurality of computing devices. In another example, the mobile computing device 102 accesses the connection quality data 206 by retrieving the connection quality data 206 already stored in the memory area 204 (e.g., without connecting to the cloud service 104). The connection quality data 206 for a particular network 108 may include a score for that network 108. The score represents a value calculated from the crowdsourced data. As an example, the score for a particular network 108 may be calculated as a mean opinion score (e.g., to objectively qualify the quality of a voice call made using that particular network 108).

At 306, the mobile computing device 102 customizes, personalizes, or otherwise adjusts the accessed connection quality data 206 based on the device context 208 (e.g. stored in the memory area 204) to produce the context-specific quality scores 210, ratings, or other metrics for each of the networks 108. In some embodiments, the quality scores are specifically generated for the application 110 that requested the network connection.

The device context 208 may be continually updated separate from the operations illustrated in FIG. 3, and/or be generated, captured, and/or determined just before adjusting the connection quality data 206. Adjusting the connection quality data 206 is performed by one or more algorithms, such as machine learning algorithms and technologies.

In some embodiments, adjusting the accessed connection quality data 206 includes, but is not limited to modifying the connection quality data 206 to indicate which network 108 is more likely to meet the current needs of the requesting application 110. As an example, the connection quality data 206 is modified based on a type of the requesting application 110 (e.g., video chat), an operating system executing on the mobile computing device 102, and/or a network protocol. In another example, the connection quality data 206 is adjusted based on an estimated network data consumption cost and/or a power consumption cost. In such an example, the mobile computing device 102 estimates the network data consumption cost and/or the power consumption cost, and then adjusts the connection quality data 206 based on those estimated costs to produce the context-specific quality score 210. For example, a low context-specific quality score 210 may result if the network data consumption cost and/or the power consumption cost are high. In another example, a high context-specific quality score 210 may result if the network data consumption cost and/or the power consumption cost are low. In some embodiments, estimating the network data consumption includes calculating current network performance (e.g., via test packets), and then predicting specific network usage for the requested transmission.

The connection quality data 206 may also be adjusted based on other data sources available to the mobile computing device 102. In some embodiments, the mobile computing device 102 may adjust the connection quality data 206 based on calendar data, information in electronic mail messages, task data, and the like. For example, if the calendar data indicates that the user 106 is about to embark on a morning commute or otherwise change locations, the mobile computing device 102 may produce a higher context-specific quality score 210 for a cellular network than for a home Wi-Fi network (e.g., because the Wi-Fi network will become unavailable once the user 106 begins the commute).

In some embodiments, the adjustment to the connection quality data 206 may result in disqualifying some networks 108 despite having a good baseline score from the cloud service 104. For example, the mobile computing device 102 may disqualify a network 108 that is not voice over Internet Protocol (VoIP) capable, if the requesting application 110 is attempting to initiate a VoIP call, based on a current below-average radio quality condition of the mobile computing device 102. In other embodiments, the connection quality data 206 itself includes an indicator of whether the particular network 108 is expected to provide “great” VoIP quality, “good” VoIP quality, “acceptable” VoIP quality, or no VoIP service.

As an example, the mobile computing device 102 produces the context-specific quality scores 210 by ordering the networks 108 as follows: free Wi-Fi networks, paid Wi-Fi networks the user 106 has access to, and then cellular networks. Among the free Wi-Fi networks, those networks known to be home or work Wi-Fi networks may be scored higher. Further, networks with a large dwell time for the user 106 (e.g. networks to which the user 106 has previously connected for a long time) may be scored higher, as are networks that the user 106 has previously connected to.

At 308, the mobile computing device 102 selects one of the networks 108 for connection based on the context-specific quality scores 210. In some embodiments, the mobile computing device 102 ranks or otherwise prioritizes the networks 108 based on their corresponding context-specific quality scores 210, and then selects the top-ranked network 108.

At 310, the mobile computing device 102 provides a single network connection endpoint to the requesting application 110. The application 110 uses the network connection endpoint to connect to the selected network 108. The single network connection endpoint abstracts the network connection details from the application 110 (e.g., the protocol, security, privacy, speed, network interface type, etc.) and abstracts the connection management (e.g., caching, maintenance, etc.). For example, the mobile computing device 102 may selectively secure some network connections, such as securing a VoIP call with a virtual private network (VPN). Such security, and the details of the security, remain abstracted from the requesting application 110 in some embodiments.

As an example, the network connection endpoint takes the form of an identifier, such as “Network”. In this example, the application 110 then sends data by invoking a function call such as Send(Network,Data) to send Data over the Network. Similarly, the application 110 may receive data by invoking a function call such as Receive(Network,Data) to receive Data over the Network.

The mobile computing device 102 may select two or more of the networks 108 at 308. In such embodiments, the mobile computing device 102 establishes a plurality of simultaneous network connections, such as a cellular connection, a Wi-Fi connection (or multiple Wi-Fi connections, real and/or virtual), and/or a BLUETOOTH brand connection. In these embodiments, the mobile computing device 102 still provides a single, abstracted network connection endpoint to the requesting application 110, but routes data received from (or sent to) the requesting application 110 over one or more of the simultaneous network connections. For example, the mobile computing device 102 may route data over a Wi-Fi connection rather than a cellular connection when the Wi-Fi connection is faster than a cellular connection. In another example, the mobile computing device 102 may route data over the cellular connection if the Wi-Fi connection prohibits particular data traffic (e.g., streaming video). In still another example, the mobile computing device 102 may multiplex data over multiple connections to improve the quality (e.g., reduce error rate, increase speed, etc.).

In some embodiments, the requesting application 110 (or user 106) may override the network selection. For example, the requesting application 110 may select a different one of the networks 108 for connection before or after connecting to the network 108 selected by the mobile computing device 102.

After selecting the network 108 for connection at 308 and connecting to the network 108, the requesting application 110 or user 106 may provide real-time feedback to the mobile computing device 102 describing the quality of experience using the selected network 108, such as network traffic congestion, jitter, latency, and the like. The mobile computing device 102 may then re-score the networks 108 in near-real time to ensure that other applications 110 will benefit from scores that are more accurate.

Similarly, after selecting the network 108 for connection at 308 and connecting to the network 108, the mobile computing device 102 may provide feedback to the cloud service 104. For example, the mobile computing device 102 may transmit data describing the output of the operations illustrated in FIG. 3, such as the adjusted connection quality data 206 (and how the connection quality data 206 was adjusted), the context-specific quality scores 210 for each of the networks 108 along with identification of the requesting application 110, and the network 108 selected for connection. The mobile computing device 102 may also provide data describing the experience with the network 108, such as throughput and latency. In this manner, the cloud service 104 may modify the connection quality data 206 stored by the cloud service 104 with the feedback to improve the accuracy and/or relevance of the connection quality data 206.

After connecting to the selected network 108, the mobile computing device 102 may transition from the selected network 108 to another network 108 without disrupting any ongoing data transmissions to/from the application 110. For example, if the selected network 108 is a cellular network and a Wi-Fi network becomes available, the mobile computing device 102 may transition the connection from the cellular network to the Wi-Fi network. However, such a transition may be hidden from the application 110 because of the use of the single network connection endpoint by the application 110.

Referring next to FIG. 4, an exemplary flow chart illustrates operation of a computing device to calculate context-specific quality scores 210 for available networks 108, and to present the networks 108 and scores to the user 106 for selection. In some embodiments, such as next described, the computing device is the mobile computing device 102 illustrated in FIG. 1 and FIG. 2. However, aspects of the disclosure contemplate performance of the operations illustrated in FIG. 4 by entities other than the computing device, such as the cloud service 104. Further, while some operations are described with reference to execution of the computer-executable components stored in the memory area 204, one or more of the operations may be performed by other components or modules of the mobile computing device 102.

At 402, the API component 212, when executed by the processor 202, causes the processor 202 to receive a request from one of the applications 110 for a network connection. At 404, the communications interface component 214, when executed by the processor 202, causes the processor 202 to access connection quality data 206 for each of the networks 108 available to the mobile computing device 102. In some embodiments, the communications interface component 214 includes a network interface card and/or computer-executable instructions (e.g. a driver) for operating the network interface card. Communication between the mobile computing device 102 and other devices may occur using any protocol or mechanism over any wired or wireless connection. Some embodiments contemplate a plurality of communications interface components 214, one for each type of network connection. For example, there may be separate communications interface components 214 for cellular networks, Wi-Fi networks, and near-field communication (NFC).

At 406, the supplementation component 216, when executed by the processor 202, causes the processor 202 to adjust the connection quality data 206, accessed by the communications interface component 214, based on the device context 208 to produce the context-specific quality score 210 for each of the networks 108.

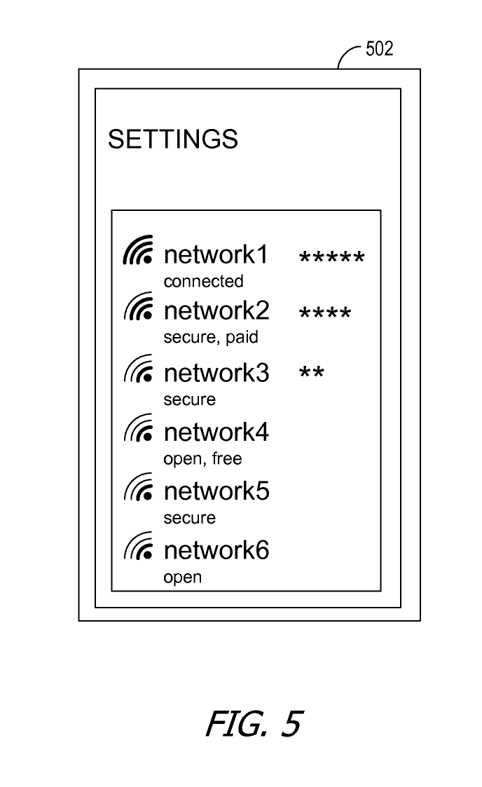

At 408, the UI component 218, when executed by the processor 202, causes the processor 202 to present, to the user 106, identifiers for a set of the networks 108 along with the corresponding context-specific quality scores 210. For example, the UI component 218 displays network identifiers and a star rating, such as shown in FIG. 5. The star ratings represent the expected quality of the networks 108, which is based on the collected historical information. The set of networks 108 may represent a subset of the networks 108 available to the user 106. For example, the UI component 218 may display only a threshold quantity of the available networks 108 (e.g., the top-ranked five networks 108). The UI component 218 may also display other information, such as the configuration settings for connecting to each network 108 (e.g., when the user 106 right-clicks one of the networks 108, the configuration settings may be displayed).

In some embodiments, the UI component 218 includes a graphics card for displaying data to the user 106 and receiving data from the user 106. The UI component 218 may also include computer-executable instructions (e.g., a driver) for operating the graphics card. Further, the UI component 218 may include a display (e.g., a touch screen display or natural user interface) and/or computer-executable instructions (e.g., a driver) for operating the display. The UI component 218 may also include one or more of the following to provide data to the user 106 or receive data from the user 106: speakers, a sound card, a camera, a microphone, a vibration motor, one or more accelerometers, a BLUETOOTH brand communication module, global positioning system (GPS) hardware, and a photoreceptive light sensor. For example, the user 106 may input commands or manipulate data by moving the mobile computing device 102 in a particular way.

In some embodiments, the supplementation component 216 may further recommend one or more of the networks 108. For example, the supplementation component 216 may recommend the network 108 with the highest context-specific quality score 210 among the context-specific quality scores 210 calculated for the requesting application 110. The UI component 218 may differentiate the identifier for the recommended network 108 in the UI from the other identifiers displayed in the user interface. For example, the identifier for the recommended network 108 may be highlighted, shaded, italicized, labeled as “recommended”, or otherwise distinguished from the other identifiers. In a further example, the supplementation component 216 may further label or qualify one or more of the identifiers based on the context-specific quality scores 210. Exemplary labels include, but are not limited to, “popular”, “favorite”, “recently added”, “hot”, and the like.

At 410, the UI component 218 receives selection of one of the presented identifiers. The communication interface component establishes, activates, or otherwise readies the network connection to allow the requesting application 110 to connect to the selected network 108 and send/receive data over the network connection.

At 412, the UI component 218 presents characteristics of the selected network 108 to the user 106. For example, the UI component 218 displays settings for upload bandwidth, download bandwidth, protocol, and/or security. The UI component 218 provides sliders, radio buttons, data entry fields, and/or other UI elements to allow the user 106 to adjust the displayed characteristics. For example, the UI component 218 receives a value from the user 106 to change one of the characteristics of the selected network 108. The UI component 218 receives the adjustments from the user 106 and applies the adjustments to adjust the network connections at 414.

Referring next to FIG. 5, an exemplary user interface 502 illustrates the context-specific quality scores 210 for a plurality of the networks 108 available to the mobile computing device 102. In the example of FIG. 5, the mobile computing device 102 has calculated the context-specific quality scores 210 for the requesting application 110. The context-specific quality scores 210 are displayed in the user interface 502 along with identifiers for the networks 108. In this example, the network identifiers include “network1”, “network2”, “network3”, “network4”, “network5”, and “network6”. The first three networks displayed have star ratings, which represent the context-specific quality scores 210 corresponding to those networks. In this example, “network1” has a 5-star rating, “network2” has a 4-star rating, and “network3” has a 2-star rating. As such, the user 106 should be inclined to select “network1”, although the user 106 may choose other networks. The user interface 502 further indicates which network connections are secure versus open, and paid versus free. For example, connecting to “network4” may be “free” to the user 106 under a data plan of the user 106.

In the example of FIG. 5, “network4”, “network5”, and “network6” have a context-specific quality score 210 of zero. In some embodiments, the context-specific quality score 210 of zero indicates that the cloud service 104 has not crowdsoureed enough data to produce connection quality data 206 for the network 108. The application 110 may view a low context-specific quality score 210 as a sign that the network 108 may be a rogue network (e.g., a network access point with malicious intent, rather than a legitimate portal). As such, the application 110 and/or the mobile computing device 102 may have a policy that prohibits connection to networks 108 with a context-specific quality score 210 below a pre-defined threshold (e.g. 1-star or less).

Alternatively or in addition, the mobile computing device 102 and/or cloud service 104 may perform packet tracing with test packets to determine where data is transmitted when connected to particular networks 108. If the test packets are determined to be routed to servers known to be malicious or suspicious (e.g., outside the current country), the mobile computing device 102 and/or cloud service 104 may identify those networks 108 as rogue. The user interface 502 may be updated to reflect the rogue status, or the network 108 may be removed from the user interface 502.

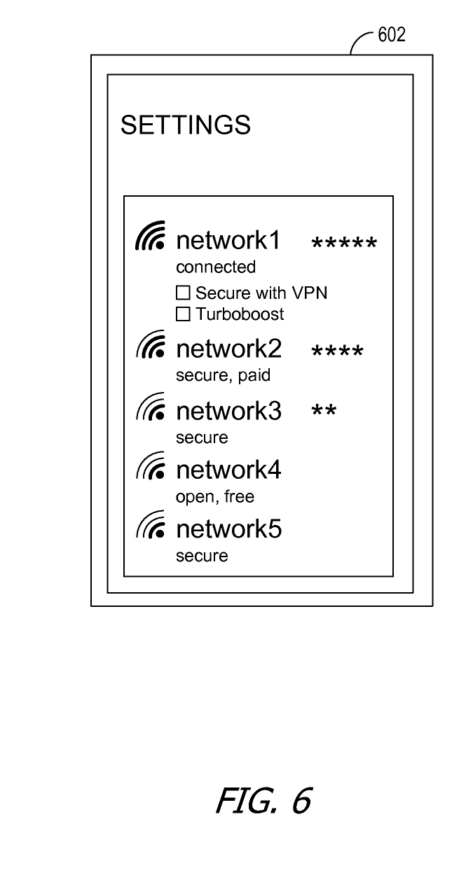

Referring next to FIG. 6, an exemplary user interface 602 illustrates network characteristics available for adjustment by the user 106. For example, the user 106 may secure a particular network 108 by requesting security by selecting one of the radio buttons displayed in the user interface 602.

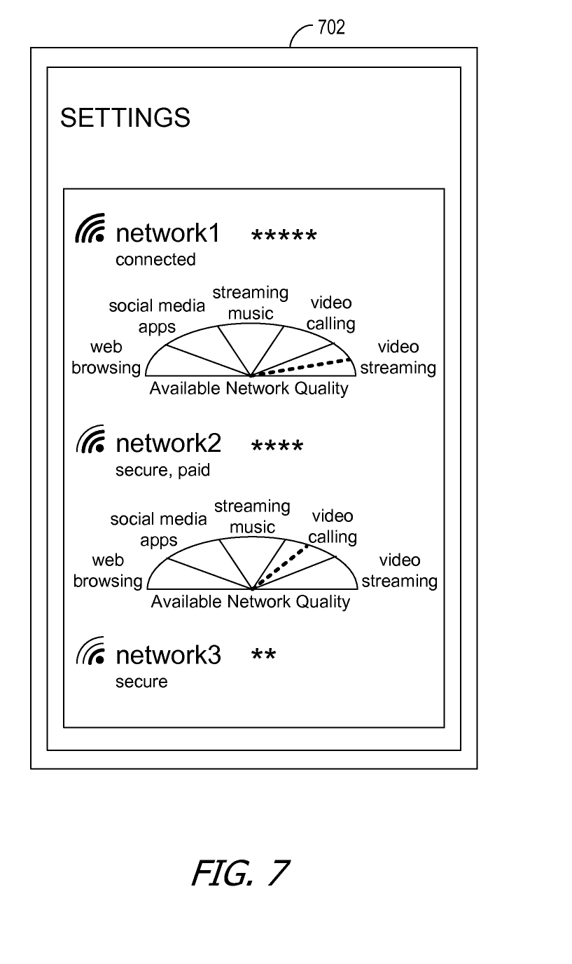

Referring next to FIG. 7, an exemplary user interface 702 illustrates suggested applications 110 based on network performance. In the example of FIG. 7, network 1 is capable of video streaming, video calling, streaming music, supporting social media applications, and web browsing. Further, network 2 is capable of video calling, streaming music, supporting social media applications, and web browsing, but not video streaming.

The information displayed in FIG. 7 indicates the type of experience expected through each available network, based on historical network performance (e.g. the context-specific quality scores 210). For some of the networks, the quality score is shown before the user 106 connects to the network 108. The user interface 702 includes visual cues such as the dotted line shown in FIG. 7, red/yellow/green color-coded areas indicating what types of applications may be executed, and the like.

In some embodiments, the user interface 702 provides the user 106 with information on changes to the selected network connection which may have a positive or negative impact on network connection experience (e.g., applications now available that were previously unavailable). The information may also be presented as context-aware notifications, such as pop-ups.

Alternatively or in addition, the application 110 may request that the particular network 108 be secured. In some embodiments, a network layer on the mobile computing device 102 knows that data for a particular requesting application 110 should be secured, and only displays networks 108 for which security is available. In such an example, the mobile computing device 102 may further automatically secure the connections.

### Additional Examples

The score in the connection quality data 206 received by the mobile computing device 102 from the cloud service 104 may be tailored to the mobile computing device 102 based on any parameters of the mobile computing device 102 known to the cloud service 104. For example, when requesting the connection quality data 206, the mobile computing device 102 may provide the device context 208 to the cloud service 104, and the cloud service 104 customizes the connection quality data 206 in view of the device context 208. The mobile computing device 102, upon receipt of the customized connection quality data 206, may further adjust the connection quality data 206 based on an updated device context 208.

In an example scenario supported by aspects of the disclosure, the user 106 is in a local café and places a call with the mobile computing device 102. As the user 106 is placing the call, the mobile computing device 102 has already automatically and silently scanned for all the available networks 108 nearby, determined which networks 108 the mobile computing device 102 can obtain access to, has ranked the networks 108, and selected one of the networks 108 for connection. By the time the user 106 hits the call button, the mobile computing device 102 has automatically connected to the café's free Wi-Fi hotspot. The user 106 is excited to be able to make an affordable call with great audio quality.

In another example scenario supported by aspects of the disclosure, the user 106 is consuming data on a cellular network by watching a movie. While watching the movie, the mobile computing device 102 determines that the user 106 has exceeded the amount of data included with the data plan of the user 106. The mobile computing device 102 detects nearby networks 108, ranks the available Wi-Fi networks, selects a free Wi-Fi network, connects to the free Wi-Fi network, and transitions the current connection of the user 106 from the cellular network to the Wi-Fi network, without interrupting the user 106 or streaming of the movie.

In another example scenario, the user 106 is at a restaurant catching up with a friend, and wants to show a video on the mobile computing device 102. The user 106 pulls out the mobile computing device 102 and starts streaming the video. Because the mobile computing device 102 has automatically connected to the restaurant's open Wi-Fi network, the user 106 enjoys the streaming video at no cost. A few days later, the user 106 meets the friend at a coffee shop that has a slow, unreliable Wi-Fi network. The mobile computing device 106, in accordance with aspects of the disclosure, does not auto-connect to this Wi-Fi network because of the poor quality score. The user 106 may, however, choose to manually connect to this Wi-Fi network.

In another example scenario supported by aspects of the disclosure, the mobile computing device 102 of the user 106 connects to a first Wi-Fi network with a lower quality score than a second Wi-Fi network because the signal strength from the second Wi-Fi network is too weak to ensure a reliable connectivity experience.

In another example scenario, the mobile computing device executes the functionality described herein to connect to a home Wi-Fi network over a nearby coffee shop Wi-Fi network, even though the coffee shop Wi-Fi network has a greater quality score, based on a preference of the user 106 to always connect to the home Wi-Fi network when in range.

In another example scenario, the user 106 is riding a bus through traffic. The mobile computing device 102 detects a passing coffee shop Wi-Fi network, but does not try to connect because the mobile computing device 102 recognizes that the Wi-Fi network access point is in a fixed location, and that the mobile computing device 102 is moving. Later, the bus is outfitted with an onboard Wi-Fi network. The mobile computing device 102 connects to the onboard Wi-Fi network because this hotspot moves with the mobile computing device 102.

In another example scenario, the user 106 is visiting a different city. The user 106 notices that the mobile computing device 102 does not seem to show quality scores about many of the detected Wi-Fi networks around the city, because the mobile computing device 102 has downloaded, over a cellular network, the quality scores only for nearby networks. Overnight, or after establishing access to one of the Wi-Fi networks, the mobile computing device 102 downloads the quality scores for more of the local Wi-Fi networks. The user 106 then notices that the mobile computing device 102 displays the quality scores for many more networks around the city.

In another example, the user 106 has an unlimited data plan. The user 106 configures the mobile computing device 102 to not auto-connect to any open Wi-Fi networks due to the varying quality of those networks. When traveling, the user 106 re-configures the mobile computing device 102 to start auto-connecting to open Wi-Fi networks to avoid roaming costs.

In another example scenario, the user 106 notices that the quality of the Wi-Fi network is poor. The user 106 chooses to stop auto-connecting to this particular Wi-Fi network, and the mobile computing device 102 then will not auto-connect to that W-Fi network for a defined amount of time (e.g., never again, not for 24 hours, etc.). The mobile computing device 102 communicates the user preference to the cloud service, which decrements the quality score for the Wi-Fi network. In this manner, the feedback from the user 106 helps other users.

At least a portion of the functionality of the various elements in FIG. 1 and FIG. 2 may be performed by other elements in FIG. 1 and/or FIG. 2, or an entity (e.g., processor, web service, server, application program, computing device, etc.) not shown in FIG. 1 or FIG. 2.

In some embodiments, the operations illustrated in FIG. 3 and FIG. 4 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The term “Wi-Fi” as used herein refers, in some embodiments, to a wireless local area network using high frequency radio signals for the transmission of data. The term “BLUETOOTH” as used herein refers, in some embodiments, to a wireless technology standard for exchanging data over short distances using short wavelength radio transmission. The term “cellular” as used herein refers, in some embodiments, to a wireless communication system using short-range radio stations that, when joined together, enable the transmission of data over a wide geographic area. The term “NFC” as used herein refers, in some embodiments, to a short-range high frequency wireless communication technology for the exchange of data over short distances.

While no personally identifiable information is tracked by aspects of the disclosure, embodiments have been described with reference to data monitored and/or collected from the users 106. In some embodiments, notice may be provided to the users 106 of the collection of the data (e.g., via a dialog box or preference setting) and users 106 are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. In some embodiments, computer storage media are implemented in hardware. Exemplary computer storage media include hard disks, flash drives, and other solid-state memory. In contrast, communication media embody computer readable instructions, data structures, program modules, or other data in a modulated data signal such as a carrier wave or other transport mechanism and include any information delivery media.

Although described in connection with an exemplary computing system environment, embodiments of the disclosure are capable of implementation with numerous other general purpose or special purpose computing system environments, configurations, or devices.

Examples of well-known computing systems, environments, and/or configurations that may be suitable for use with aspects of the invention include, but are not limited to, mobile computing devices (e.g., mobile computing device 102), personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user 106 in any way, including from input devices such as a keyboard or pointing device, via gesture input, proximity input (such as by hovering), and/or via voice input.

Embodiments of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for selecting networks 108 for connection based on context-specific quality scores 210. For example, one or more of the embodiments contemplate means for receiving a request from the application 110 for a network connection, accessing the connection quality data 206 for the networks 108, adjusting the connection quality data 206 based on the device context 208 to produce the context-specific quality score 210 for each of the networks 108, selecting one or more of the networks 108 based on the context-specific quality scores 210, and providing a single network connection endpoint to the application 110 for connection to the selected networks 108.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including.” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for selecting networks for connection based on application-specific quality scores, said system comprising:
a memory area associated with a mobile computing device, said memory area storing connection quality data for each of a plurality of networks, the connection quality data being derived from crowdsourced data received from a plurality of computing devices, the memory area further storing a device context and one or more applications; and
a processor programmed to:
receive a request from one of the applications for a network connection;
access the connection quality data stored in the memory area for each of the plurality of networks;
adjust the accessed connection quality data based on the device context stored in the memory area to produce an application-specific quality score for each of the plurality of networks;
select one or more of the plurality of networks based on the application-specific quality scores; and
provide a single network connection endpoint to said one of the applications for connection to the selected one or more of the plurality of networks.

2. The system of claim 1, wherein the device context stored in the memory area comprises at least one of a battery level, signal strengths for the plurality of networks, network types for the plurality of networks, network speeds for the plurality of networks, a location of the mobile computing device, a user identifier, a user profile, device conditions, user preferences, a usage scenario, an identifier of said one of the applications, a device type, device movement, weather local to the mobile computing device, or a remaining network data consumption amount under a data plan.

3. The system of claim 1, wherein the processor is further programmed to estimate, for the network connection, at least one of a network data consumption cost, or a power consumption cost.

4. The system of claim 1, wherein the accessed connection quality data has attributes associated therewith, the attributes including at least one of a time of day, a rating, an expiration value, or a confidence level.

5. The system of claim 1, wherein the processor is further programmed to determine the device context.

6. The system of claim 1, wherein the processor is further programmed to establish a plurality of simultaneous connections and to abstract the established plurality of simultaneous connections from said one of the applications via the provided, single, network connection endpoint.

7. The system of claim 6, wherein the established plurality of simultaneous connections comprises a cellular connection and a wireless fidelity (Wi-Fi) connection.

8. The system of claim 1, wherein the plurality of networks include at least one of a network to which the mobile computing device is currently connected, or a network to which the mobile computing device is currently disconnected.

9. The system of claim 1, wherein the processor is further programmed to rank the plurality of networks based on the application-specific quality scores.

10. The system of claim 1, wherein the memory area stores a plurality of the applications, and wherein different applications have different quality scores for at least one of the plurality of networks.

11. A method comprising:
receiving, by a mobile computing device, a request from an application for a network connection, the mobile computing device having a device context associated therewith;
accessing, by the mobile computing device, connection quality data for each of a plurality of networks, the connection quality data being derived from crowdsourced data received from a plurality of computing devices;
adjusting the accessed connection quality data based on the device context to produce an application-specific quality score for each of the networks; and
selecting, by the mobile computing device, one or more of the plurality of networks for connection based on the application-specific quality scores.

12. The method of claim 11, wherein accessing the connection quality data comprises receiving the connection quality data from a cache local to the mobile computing device.

13. The method of claim 11, wherein accessing the connection quality data comprises accessing a cloud service, and further comprising transmitting, to the cloud service as feedback, at least one of the adjusted connection quality data, the application-specific quality scores, or the selected one or more of the plurality of networks.

14. The method of claim 11, wherein selecting the one or more of the plurality of networks comprises selecting one of the plurality of networks, and further comprising securing the selected one of the plurality of networks with a virtual private network (VPN).

15. The method of claim 11, wherein adjusting the accessed connection quality data comprises adjusting based on at least one of a type of the application, an operating system executing on the mobile computing device, or a network protocol.

16. The method of claim 11, further comprising receiving a request from the application to select a different one of the networks for connection before or after connecting to the selected one or more of the plurality of networks.

17. One or more computer storage media embodying computer-executable components, said components comprising:
an application programming interface component that when executed causes at least one processor to receive, by a computing device, a request from an application for a network connection, the computing device having a device context associated therewith;
a communications interface component that when executed causes at least one processor to access, by the computing device, connection quality data for each of a plurality of networks, the connection quality data being derived from crowdsourced data received from a plurality of computing devices;
a supplementation component that when executed causes at least one processor to adjust the connection quality data, accessed by the communications interface component, based on the device context to produce a context-specific quality score for each of the plurality of networks; and
a user interface component that when executed causes at least one processor to present, to a user, identifiers for a set of the plurality of networks and the context-specific quality scores associated therewith.

18. The computer storage media of claim 17, wherein the user interface component further receives a value from the user to change a characteristic of at least one of the networks in the set, the characteristic comprising at least one of a network protocol, a network speed, a security setting, or a privacy setting.

19. The computer storage media of claim 17, wherein the supplementation component further recommends one of the networks from the set for connection based on the context-specific quality scores.

20. The computer storage media of claim 19, wherein the user interface component further differentiates the identifier for the recommended one of the networks in the user interface from the other identifiers presented in the user interface.
